(19) United States
(12) Patent Application Publication
(10) Pub. No.: US 2010/0270047 A1
(43) Pub. Date: Oct. 28, 2010

(54) Hand-held power tool

(75) Inventors: Hans Appel, Muenchen (DE); Jens Imaschewski, Muenchen (DE)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/799,235

(22) Filed: Apr. 21, 2010

(30) Foreign Application Priority Data
Apr. 23, 2009 (DE) 10 2009 002 589.8

(51) Int. Cl. B25D 17/24; B25F 5/02

(52) U.S. Cl. 173/162.2

(57) ABSTRACT

A hand-held power tool includes a machine housing, a handle, and a damping device that couples the handle to the machine housing. The damping device is configured to be star-shaped with three elastic struts, whereby a first strut and a second strut are joined to the machine housing, while a third strut is joined to the handle.

This claims the benefit of German Patent Application DE 10 2009 002 589.8, filed Apr. 23, 2009 and hereby incorporated by reference herein.

The invention relates to a hand-held power tool, especially to a hand-held power tool with a striking mechanism.

### BACKGROUND

German Patent Application DE 41 24 574 A1 describes a hammer drill whose handle is joined to a machine housing via damping elements. The damping elements are intended to reduce vibrations that occur in the machine housing. At the same time, a user has to be able to exert a holding force on the machine housing and on a tool via the damping elements. The handle is coupled via a damped pivot bearing and a damped bearing that runs parallel to the striking axis. The damped bearings are in one plane.

### SUMMARY OF THE INVENTION

It is an object of the present invention to provide a suspension for the handle that damps vibrations in the longitudinal direction and in the vertical direction, and that is stable in the crosswise direction.

The present invention provides a hand-held power tool including a machine housing, a handle, and a damping device that couples the handle to the machine housing. The damping device is configured to be star-shaped with three elastic struts, whereby a first strut and a second strut are joined to the machine housing, while a third strut is joined to the handle. The three-point attachment and star-shaped configuration reduce the mobility in a plane that is defined by the attachment points of the struts.

One embodiment provides for an area that connects the first strut to the machine housing to be situated on one side of a symmetry plane of the machine housing, and for an area that connects the second strut to the machine housing to be situated on another side of the symmetry plane. The damping device can be configured symmetrically to the third strut.

One embodiment provides for areas that connect the first and second struts to the machine housing to be arranged opposite from an area that connects the third strut to the handle at a different vertical distance from a striking axis of the hand-held power tool.

One embodiment provides for the damping device to be arched relative to a plane defined by the areas that connect the three struts to the handle and to the machine housing.

One embodiment provides for a surface of the damping device to face in a first direction in the area of the handle and for it to face in a second direction in the area of the hand-held power tool, whereby the first and second directions are at an angle between 70° and 90°.

One embodiment provides for the damping device to take up the entire width of the machine housing in the area of its connection.

### BRIEF DESCRIPTION OF THE DRAWINGS

The description below explains the invention with reference to examples of embodiments and figures. The following is shown:

FIG. 1—a side view of a hammer drill,

FIG. 2—a partial view of the hammer drill and

FIG. 3—a top view of the hammer drill.

### DETAILED DESCRIPTION

Unless otherwise indicated, identical or functionally equivalent elements are indicated by the same reference numerals in the figures.

FIG. 1 shows an example of a hammer drill 1. A motor 3, a tool receptacle 4 and a striking drill mechanism 5 are arranged in a machine housing 2 of the hammer drill 1. The hammer drill 1 can be held by a handle 6 that is joined to the machine housing 2. The machine housing 2 and the handle 6 are at least partially vibration-uncoupled from each other by means of an elastic suspension. Bellows 7 can cover the suspension.

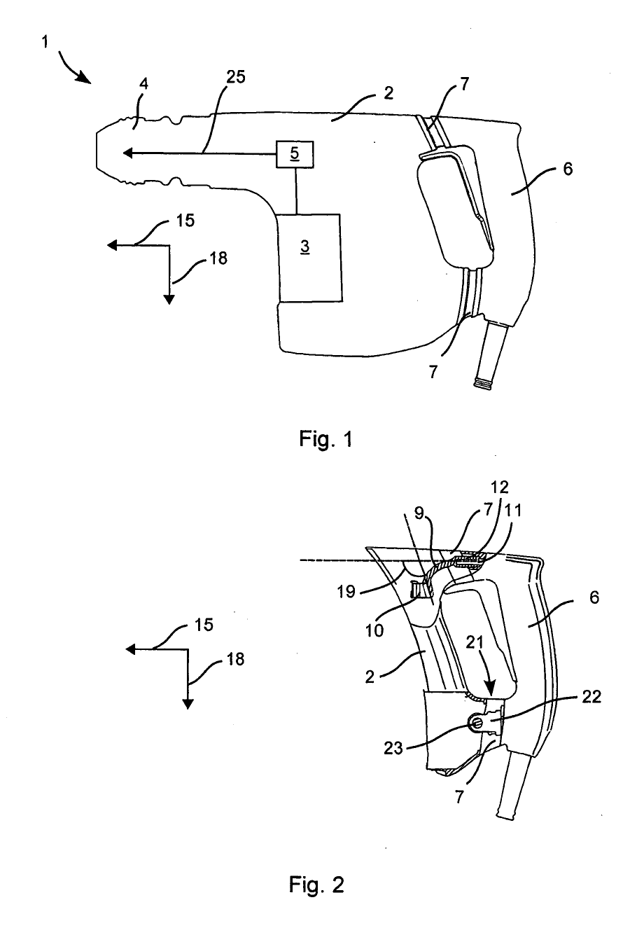

FIG. 2 shows the handle 6 with a partially exposed suspension. An upper suspension 8 has a damping device 9 that is attached at two anchor points 10 to the machine housing 2 and at one anchor point 11 to the handle 6.

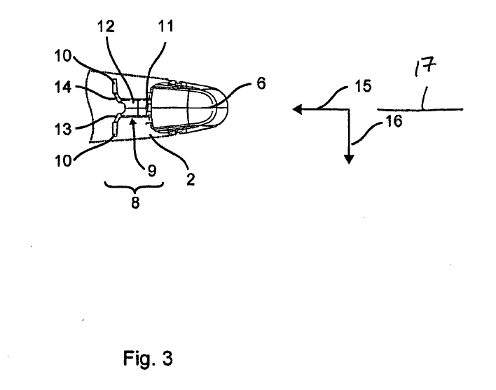

FIG. 3 shows a top view of the upper suspension 8. The machine housing 2 is depicted as being transparent. The damping device 9 has three elastic struts 12, 13, 14. The three struts 12, 13, 14 form a T-shaped or star-shaped body. The first strut 12 is oriented essentially parallel to a longitudinal axis 15 of the hammer drill. The two other struts are oriented essentially parallel to the transverse axis 16 of the hammer drill 1. The transverse axis 16 runs perpendicular to the longitudinal axis 15 and to a symmetry plane 17 through the hammer drill 1, i.e. from right to left. Axes 15 and 18 thus lie in symmetry plane 17.

The second and third struts can be approximately as long as half the width of the machine housing; the width is measured at this height along the striking axis 15. Consequently, the damping device 9 can take up essentially the entire width within the machine housing 2. The first strut 12 is attached by the anchor point 11 to the handle, and the two other struts 13, 14 are attached by the two anchor points 10 in the machine housing 2.

A lower suspension has a pivot bearing 21 that is oriented lengthwise to the transverse direction 16. The handle 6 can be pivoted relative to the machine housing 2 around the pivot bearing 21. Moreover, the pivot bearing 21 is provided with a damping device for movements in the direction of the longitudinal axis 15.

The pivot bearing includes a bearing 22 and a journal 23 held in the bearing 22. In the embodiment presented by way of an example, the bearing 22 is joined to the handle 6, while the journal is joined to the machine housing 2. In order to damp movements in the direction of the longitudinal axis 15, the journal 23 can be at least partially sheathed with an elastic material.

In one embodiment, the upper suspension can have a curved structure. The damping device 9, projected onto the symmetry plane 17, has a curvature. The associated curvature radius is preferably situated on the side of the damping device 9 on which the pivot bearing 21 is also situated, that is to say, the curvature is about the pivot bearing 21. The curved damping device 9 allows a more uniform exertion of deformation forces over the entire length of the damping device 9.

The pivot bearing 21 can be curved to such an extent that an end area of the strut 12 at the anchor point 11 is tilted by more than 70° relative to an end area of the struts 13, 14 on the anchor point 13. The angle 19, as shown, can also be greater than 90°.

The anchor points 10 of the machine housing 2 can be situated closer to a striking axis 25 relative to the vertical direction 18 than to the anchor point 11 of the handle 2.

What is claimed is:

1. A hand-held power tool comprising:
a machine housing;
a handle; and
a damping device coupling the handle to the machine housing, wherein the damping device is configured to be star-shaped with three elastic struts, a first and a second strut of the three elastic struts being joined to the machine housing, a third strut of the three elastic struts being joined to the handle.

2. The hand-held power tool as recited in claim 1 wherein an area that connects the first strut to the machine housing is situated on one side of a symmetry plane of the machine housing and the area that connects the second strut to the machine housing is situated on another side of the symmetry plane.

3. The hand-held power tool as recited in claim 1 wherein the damping device is configured symmetrically to the third strut.

4. The hand-held power tool as recited in claim 1 wherein the first and second struts are arranged perpendicularly to the third strut.

5. The hand-held power tool as recited in claim 1 wherein the damping device is configured symmetrically to a symmetry plane of the handle and of the machine housing.

6. The hand-held power tool as recited in claim 1 wherein areas connecting the first and second struts to the machine housing are arranged opposite from a further area connecting the third strut to the handle at a different vertical distance from a striking axis of the hand-held power tool.

7. The hand-held power tool as recited in claim 1 wherein the damping device is arched relative to a plane defined by the areas that connect the three struts to the handle and to the machine housing.

8. The hand-held power tool as recited in claim 1 wherein a surface of the damping device faces in a first direction in an area of the handle and faces in a second direction in a further area of the hand-held power tool, the first and second directions being at an angle between 70° and 90°.

9. The hand-held power tool as recited in claim 8 wherein the handle is additionally coupled to the machine housing by a pivot bearing, a curvature of the damping device being about an axis of the pivot bearing.

10. The hand-held power tool as recited in claim 7 wherein the handle is additionally coupled to the machine housing by a pivot bearing, a curvature of the damping device being about an axis of the pivot bearing.

11. The hand-held power tool as recited in claim 1 wherein the damping device takes up an entire width of the machine housing in an area of a connection to the machine housing.
